(19) United States
(12) Patent Application Publication
(10) Pub. No.: US 2007/0082633 A1
(43) Pub. Date: Apr. 12, 2007

(54) Avoidance of wireless devices

(75) Inventors: Nicholas Michael Carbone, San Diego, CA (US); Timothy Leo Gallagher, Encinitas, CA (US); Nishant Kumar, San Diego, CA (US)

Correspondence Address: VAN PELT, YI & JAMES LLP, 10050 N. FOOTHILL BLVD #200, CUPERTINO, CA, 95014, US

(73) Assignee: Staccato Communications, Inc.

(21) Appl. No.: 11/281,260

(22) Filed: Nov. 16, 2005

Related U.S. Application Data
(60) Provisional application No. 60/725,125, filed on Oct. 6, 2005.

(51) Int. Cl. H04B 1/18

(52) U.S. Cl. 455/166.2; 375/130; 455/39

(57) ABSTRACT

Avoiding a frequency spectrum in a wireless medium is disclosed. An identification of the frequency spectrum in the wireless medium to avoid is obtained. A set of subcarriers to suppress based at least on part on the frequency spectrum to avoid is determined. Information is reallocated in response to the set of subcarriers to suppress.

### CROSS REFERENCE TO OTHER APPLICATIONS

This application claims priority to U.S. Provisional Patent Application No. 60/725,125 entitled AVOIDANCE OF WIRELESS DEVICES filed Oct. 6, 2005 which is incorporated herein by reference for all purposes.

### BACKGROUND OF THE INVENTION

As wireless devices become more common, more and more wireless devices share the wireless medium. In one example, ultrawideband (UWB) wireless devices use a band with a large bandwidth, sometimes on the order of hundreds of MHz. Wireless devices that use large bandwidths may be more likely to interfere with other wireless devices. Methods to avoid a frequency spectrum may be useful to wireless devices, including UWB wireless devices.

### BRIEF DESCRIPTION OF THE DRAWINGS

Various embodiments of the invention are disclosed in the following detailed description and the accompanying drawings.

FIG. 1 is a block diagram illustrating an example of a wireless device.

FIG. 2 is a block diagram illustrating an example of a baseband transmitter.

FIG. 3 is transmission illustrating an embodiment of discarding a symbol associated with a band to avoid.

FIG. 4 is a spectrum illustrating an embodiment of discarding data in the process of avoiding a subcarrier.

FIG. 5 is a flowchart illustrating an embodiment of selecting relatively weak encoded data to discard.

FIG. 6A is a block diagram illustrating an embodiment of components associated with rearranging encoded data so that the weakest encoded data is discarded.

FIG. 6B is a spectrum illustrating an embodiment of rearranged encoded data so that the weakest encoded data is discarded.

FIG. 7 illustrates an embodiment of a systematic code used in association with discarding data.

FIG. 8A is a transmission illustrating an embodiment of replacing an avoided band in a time frequency code with another band.

FIG. 8B is a transmission illustrating an embodiment of changing the time frequency code period to avoid a band.

FIG. 9A is a block diagram illustrating an embodiment of components associated with buffering and assigning encoded data to subcarriers that are not suppressed.

FIG. 9B is a spectrum illustrating an embodiment of suppressing subcarriers without discarding data.

FIG. 10 illustrates an embodiment of a header used to communicate information about avoidance related processing performed on a frame.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A method of avoiding a frequency spectrum in a wireless medium is disclosed. An identification of a frequency spectrum to avoid is obtained. The frequency spectrum to avoid may be defined by a bandwidth and a center frequency, or by a range of frequencies. In some embodiments, an identification of a frequency spectrum to avoid may obtained by receiving a range of frequencies, or by identifying a band used by another wireless device. A set of subcarriers to suppress is determined based at least in part on the frequency spectrum to avoid. Information is reallocated in response to the set of subcarriers to suppress. In some embodiments, reallocating information includes discarding information. A symbol of a frame may be discarded, or information associated with a subcarrier may be discarded. In some embodiments, the information discarded is selected to have relatively less or the least value compared to other information. For example, encoded data generated using a weaker code may be discarded instead of encoded data generated using a stronger code. In some embodiments, information is not discarded. For example, data may be buffered and assigned to subcarriers other than the set of subcarriers to suppress.

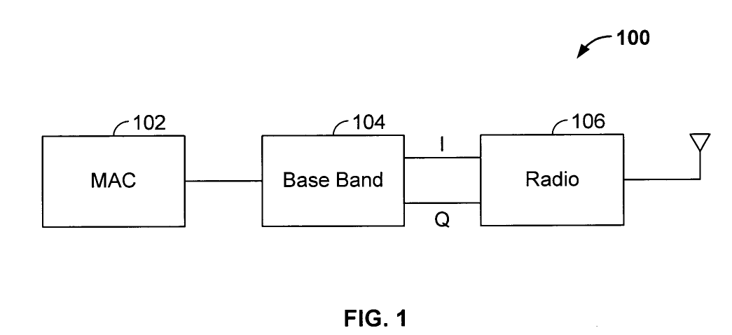

FIG. 1 is a block diagram illustrating an example of a wireless device. In the example shown, wireless device 100 may be avoiding frequencies used by another wireless device. The components shown may perform avoidance related processes. In some embodiments, wireless device 100 is a wideband wireless device (such as an IEEE 802.15.3a wireless device or a WiMedia ultrawideband (UWB) wireless device) avoiding a narrowband wireless device (such as a WiMax wireless device or a WiFi IEEE802.11 wireless device). During transmission, Medium Access Controller (MAC) 102 passes a MAC frame to baseband processor 104. Baseband processor 104 may also be referred to as a PHY. In some embodiments, a data rate associated with a MAC frame is also passed to baseband processor 104. Baseband processor 104 processes the MAC frame, for example by encoding, modulating, and interleaving the frame. A PHY header may be added to the MAC frame, and the combined PHY header and processed MAC frame may be divided into OFDM symbols. Analog I and Q signals are passed from baseband processor 104 to radio 106.

Radio 106 transmits I and Q signals from baseband processor 104 on an appropriate band. For example, if wireless device 100 is a WiMedia wireless device, a band may be 528 MHz wide and approximately in the range of 3.4 GHz to 10.3 GHz. A wireless device may select a band to use from multiple possible bands. Band hopping, also referred to as Time Frequency Interleaving (TFI), may be used in which multiple bands are used to transmit a frame. A time frequency code (TFC) may be used to describe a pattern of bands used to transmit a frame. In some embodiments, Fixed Frequency Interleaving (FFI) is used and a frame is transmitted on one band.

Corresponding inverse processes may be applied in the receive path. Radio 106 may tune to an appropriate band to obtain received I and Q signals. The received I and Q signals may be passed to baseband processor 104 for processing. A received frame is passed from baseband processor 104 to MAC 102. Additional processing may also be applied, some of which may not necessarily have a corresponding transmit process. For example, a receiver may synchronize to the timing of the transmitter to receive symbols of a frame. Baseband processor 104 may perform synchronization related processes. In some embodiments, band hopping is used and timing information is passed to radio 106 to switch bands at the appropriate time.

In some embodiments, a baseband processor performs avoidance related processes. For example, a band used by a wireless device may be divided into subcarriers and a baseband processor may process information transmitted in the subcarriers. It may be convenient to use a baseband processor to suppress one or more subcarriers in a band.

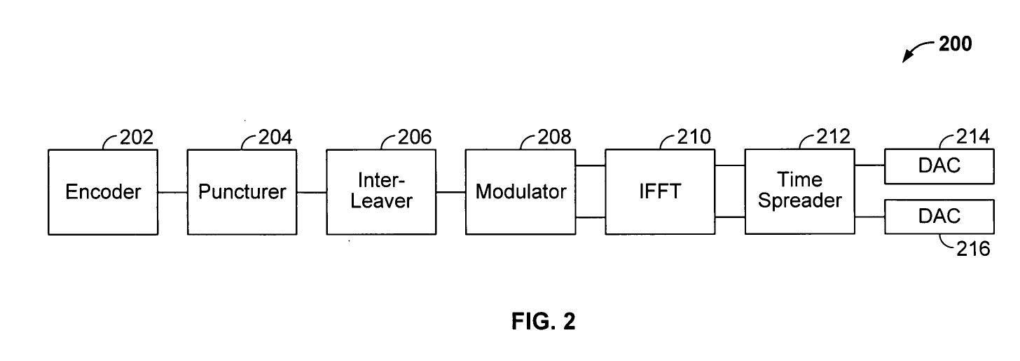

FIG. 2 is a block diagram illustrating an example of a baseband transmitter. In the example shown, baseband transmitter 200 may be a WiMedia UWB baseband avoiding a frequency spectrum. Baseband transmitter 200 may include additional components; for clarity, some components may not be illustrated. Processing performed by baseband transmitter 200 may be determined by a data rate received from a MAC.

Encoder 202 encodes transmitted data. In some embodiments, processing is applied to transmitted data before it is encoded, such as scrambling. Forward Error Correction encoding may be performed by encoder 202 to generate encoded data from input data. In some embodiments, a 1/3 code rate is used where three pieces of encoded data are output for every one piece of input data. Puncturer 204 may be used to modify a code rate. Encoded data is passed from encoder 202 to puncturer 204 and some encoded data may be removed by puncturer 204. The specific encoding and/or puncturing process performed may be determined based on a data rate specified by a MAC.

The punctured data is passed from puncturer 204 to interleaver 206. Interleaver 206 rearranges the ordering of punctured data from puncturer 204. In some embodiments, interleaving in performed within symbol boundaries. In some embodiments, interleaving is performed over multiple symbols.

Modulator 208 is coupled to interleaver 206. Quadrature Phase Shift Keying (QPSK) or Dual Carrier Modulation (DCM) may be performed by modulator 208 on interleaved data. The specific modulation process used may be based on data rate.- A constellation generated by modulator 208 is passed to Inverse Fast Fourier Transformation (IFFT) 210. A constellation generated by modulator 108 may include inphase (I) and quadradture (Q) components, and I and Q signals may be passed to IFFT 210.

IFFT 210 transforms a frequency domain signal to a time domain signal. In some embodiments, IFFT 210 is a 128 point IFFT. The 128 frequencies may include overhead, such as pilot tones or guard tones, or modulated data from modulator 208. Some or all of the 128 frequencies may be subcarriers of a band. For example, the subcarriers may span 528 MHz if baseband transmitter 200 is a WiMedia device. Constellations generated by modulator 208 are used as inputs to IFFT 210 and are assigned to an appropriate subcarrier. In some cases, a given constellation is assigned to multiple subcarriers; this is referred to as frequency domain spreading. Frequency domain spreading has redundant information in the frequency domain. For example, using frequency domain spreading, the same information is assigned to two subcarriers such that the subcarriers are symmetric about the center. Frequency spreading may be limited to lower data rates.

Time spreader 212 receives data from IFFT 210. Time spreader 212 has redundant information in the time domain. In one example, for every symbol input, two symbols may be output. The two symbols output from time spreader 212 may or may not be duplicates of each other. Time domain spreading in some cases may be used for lower data rates. For higher data rates, time spreader 212 may output one symbol for every symbol input. DACs 214 and 216 perform digital to analog conversion on I and Q outputs from time spreader 212, respectively.

In some embodiments, information, such as a symbol of a frame, is discarded in the process of avoiding a frequency spectrum. A set of subcarriers suppressed may include a band used by another wireless device.

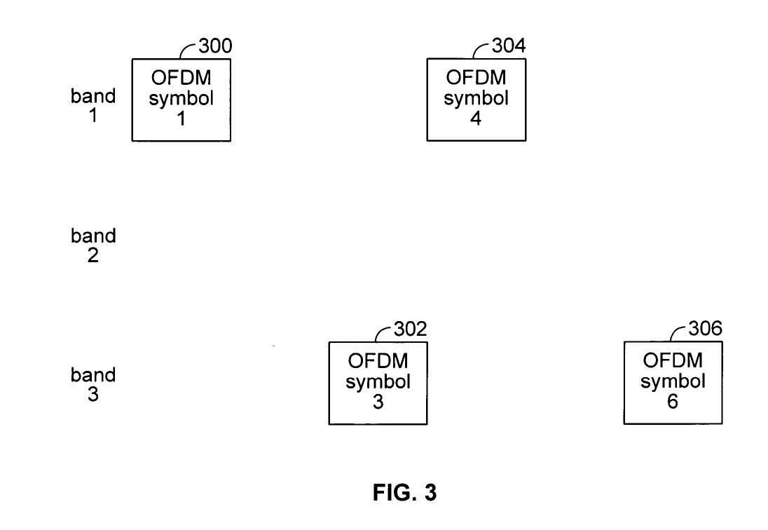

FIG. 3 is transmission illustrating an embodiment of discarding a symbol associated with a band to avoid. In the example shown, a wireless device transmitting the illustrated symbols uses a time frequency code of (band 1, band 2, band 3) to transmit OFDM symbols of a frame. Another wireless device may be using some or all of band 2 and band 2 is avoided. Symbols normally transmitted on band 2 are discarded (i.e., not transmitted). OFDM symbol 1 300 is transmitted on band 1. Band 2 is avoided and OFDM symbol 2 is discarded. OFDM symbol 3 302 is transmitted on band 3, OFDM symbol 4 304 is transmitted on band 1, OFDM symbol 5 is discarded, and OFDM symbol 6 306 is transmitted on band 3.

Power may be saved in some embodiments by turning off components when a symbol is discarded. For example, between transmission of OFDM symbol 1 300 and OFDM symbol 3 302, the radio of the transmitting wireless device may be powered down. In some embodiments, some or all of a baseband processor is turned off between OFDM symbol 1 300 and OFDM symbol 3 302.

In general, discarding information in the processing of avoiding a frequency spectrum may affect performance. For example, the transmission rate of a frame may change. For clarity, the data rate refers to an information processing rate used to determine baseband processing whereas the transmission rate is the rate over the wireless medium. If information is discarded, the transmission rate may be less than be the data rate. The error rate may also be affected by discarding information. In some cases, a receiver is unable to recover the frame without the discarded information. In some cases, a receiver is able to recover a frame but the error rate increases.

In some embodiments, a decision to discard information is based on the degree to which performance is affected. For example, if a receiver may not be able to recover a frame without discarded symbols, a wireless device may decide against discarding symbols. Or, a receiver may be able to properly receive a frame but the increased error rate may be undesirable. A wireless device may decide to not to discard information because of the undesirable degree to which the error rate increases. There may be a tendency for discarding information to be unattractive at higher data rates. For example, a WiMedia device discarding information associated with subcarriers using a 480 Mbps data rate may have a loss on the order of 9 dB. In some embodiments, deciding whether to discard information is based on data rate. Discarding information may be based on whether a data rate uses time domain spreading and/or frequency domain spreading.

A lookup table may be used to decide whether to perform a given avoidance related process based on data rate. For example, a lookup table may be used to determine whether to discard information. A table may be used to decide whether to drop symbols in a band based on data rate, or a table may be used to decide whether to discard information associated with a subcarrier.

In some embodiments, a wireless device uses one band to transmit OFDM symbols and does not perform band hopping. This may be referred to as Fixed Frequency Interleaving (FFI). A FFI wireless device may switch bands if it detects the presence of another wireless device in its current band and decides to avoid the current band. In some embodiments, an FFI wireless device signals that it is changing bands. A time associated with the change to may also be communicated. This may enable coordination of a band change with other wireless devices.

In some embodiments, information associated with a subcarrier is discarded. Rather than avoiding an entire band (and possibly discarding a significant amount of information), one or more subcarriers may be avoided and less information may be discarded.

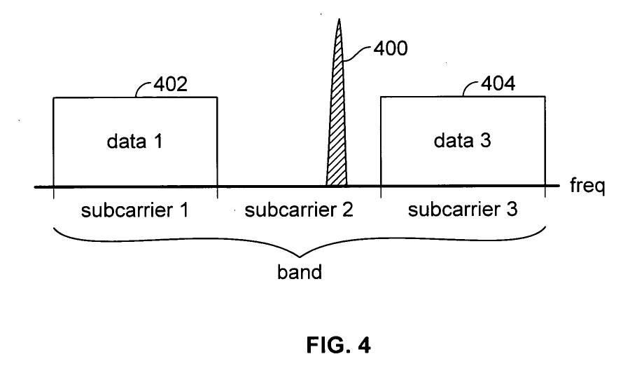

FIG. 4 is a spectrum illustrating an embodiment of discarding data in the process of avoiding a subcarrier. In the example shown, a band includes three subcarriers, each of which carries data. A band may include a different number of subcarriers (for example, WiMedia uses 100 subcarriers in a band to carry data) and some subcarriers may carry overhead information, such as pilot tones or guard tones. Another wireless device transmits signal 400 in subcarrier 2 and a set of subcarriers suppressed may include subcarrier 2. A set of subcarriers suppressed may include more than one subcarrier if signal 400 overlaps with more than one subcarrier. Data 1 402 is transmitted in subcarrier 1 and data 3 404 is transmitted in subcarrier 3. Data 2 (not shown) coincides with subcarrier 2 and is not transmitted.

In some embodiments, components of a baseband perform processes relating to avoiding subcarrier. For example, at an IFFT in a baseband transmitter, data 2 may be discarded and a value of zero may be input for subcarrier 2 instead of data 2. The transmitted signal will have a null at subcarrier 2 resulting from the value of zero passed to the IFFT. In some embodiments, a value substantially equal to zero used. In some embodiments, a zero input is inserted at a different point in a baseband transmitter besides the IFFT. Processing performed by a baseband processor is known, so an equivalent value and equivalent point in the transmit path may be determined.

In some embodiments, a set of subcarriers suppressed includes subcarriers in addition to those that are used by another wireless device. For example, subcarrier 1 and/or subcarrier 3 may be avoided even though signal 400 overlaps only with subcarrier 2. In some embodiments, more than one additional subcarrier is avoided. Avoiding additional subcarriers may enable a deeper null. It may be easier to generate a null of a given attenuation if the frequency spectrum to avoid has a larger bandwidth. In some embodiments, the width of the frequency spectrum to avoid (for example, the number of subcarriers to avoid) is selected based at least in part on a desired attenuation of the null.

Avoidance related processing, including discarded information, may be communicated to a receiving wireless device. For example, a wireless device that drops OFDM symbols may communicate this to a receiving device. Similarly, a wireless device that discards information associated with a subcarrier may communicate this to a receiving wireless device. This information may be used by a receiving device to ignore received information and use neutral values instead. Instead of using information received in subcarrier 2, a receiving wireless device may use a neutral value when processing a received signal. This may limit the introduction of noise, for example during Viterbi decoding at a receiver.

It is not, however, necessary to communicate avoidance related processing information to a receiver. In some applications, it may be desirable to limit overhead information communicated. In some applications, it may be unattractive to implement new functionality in a receiver to use a neutral value in place of a received value for a subcarrier to avoid.

In some embodiments, discarded information may be selected. Rather than discarding information that coincides with an avoided frequency spectrum, information that is relatively less valuable may be discarded. Data may be reallocated or rearranged so that less valuable data is assigned to a set of subcarriers to suppress and is discarded.

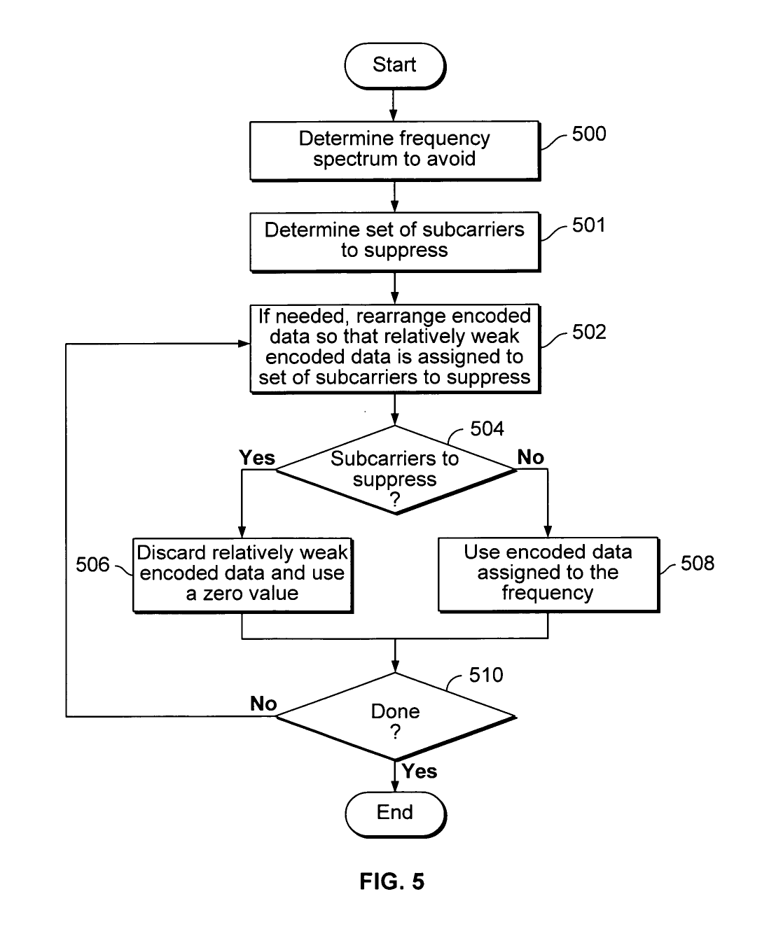

FIG. 5 is a flowchart illustrating an embodiment of selecting relatively weak encoded data to discard. In the example shown, a baseband processor performs encoding on transmitted data. A 1/3 coding rate convolutional encoder may be used where three generator polynomials are used to generate three respective encoded bits. At 500 a frequency spectrum to avoid is determined. Determining may include receiving a range of frequencies to avoid, perhaps from another component or device detecting wireless devices, or may include detecting wireless devices and identifying bands used by other wireless devices.

A set of subcarriers to suppress is determined at 501. The set of subcarriers may include subcarriers that overlap with the frequency spectrum to avoid. In some embodiments, the set of subcarriers include additional subcarriers that do not overlap with the frequency spectrum to avoid.

If needed, encoded data is rearranged so that relatively weak encoded data is assigned to the set of subcarriers to suppress at 502. Data assigned to the set of subcarriers to suppress may be discarded. In some embodiments, the weakest encoded data (i.e., has the smallest minimum free distance) is discarded. In some embodiments, the encoded data discarded is not the weakest encoded data. For example, the two weakest pieces of encoded data may be comparable in strength. A transmitter may decide to discard encoded data other than the weakest if the incremental improvement obtained by rearranging encoded data is minimal.

It is decided at 504 if it is a subcarrier to suppress. If it is a frequency spectrum to suppress, the relatively weak encoded data is discarded and a zero value is used at 506. A value of zero may be passed to an IFFT for the suppress subcarrier so that a null is transmitted. If it is not a subcarrier to suppress, at 508 the encoded data assigned to the frequency is used. At 510, a decision is made whether it is done parsing information assigned to the subcarriers. If it is done, the process ends. Otherwise, it is determined at 504 if it is a frequency spectrum to avoid.

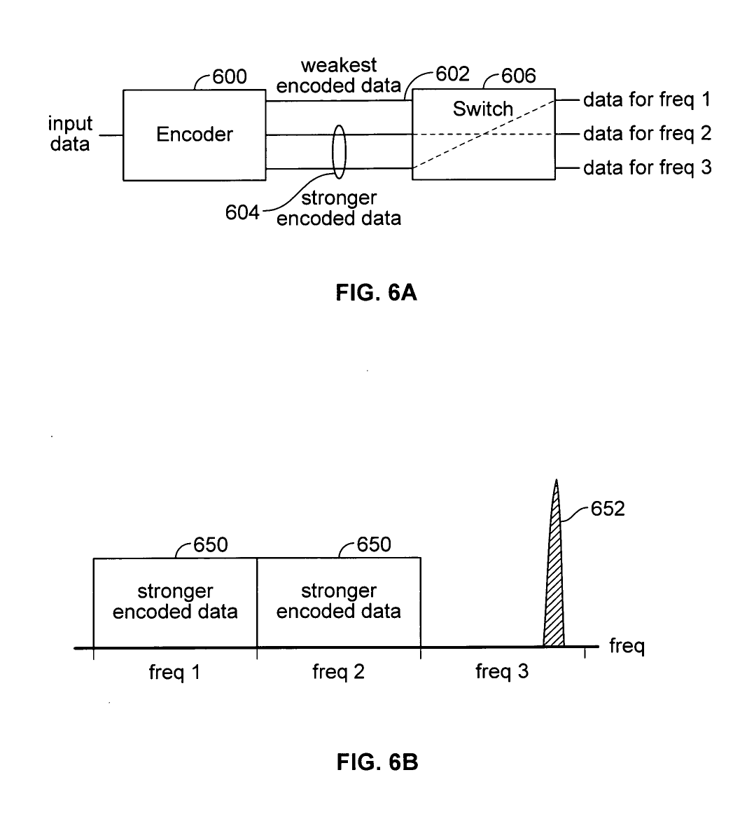

FIG. 6A is a block diagram illustrating an embodiment of components associated with rearranging encoded data so that the weakest encoded data is discarded. In the example shown, frequency 3 is avoided, perhaps because another wireless device is using some or all of frequency 3. Encoder 600 generates encoded data using input data and three generator polynomials, each of which generates one of the three encoded pieces of data. Encoded data 602 is the weakest data, perhaps generated using the weakest generator polynomial, and normally coincides with frequency 1. Stronger pieces of encoded data 604 are normally assigned to frequencies 2 and 3. Frequencies 1, 2, and 3 may be subcarriers in a band.

Switch 606 is used to rearrange the ordering of the encoded data so that the weakest encoded data is discarded. Switch 606 may include two connections. One connection maintains the normal assignment of the first stronger piece data 604 to frequency 2. The other connection reassigns the second stronger piece of data 604 to frequency 1. In this example, switch 606 does not include a connection for weakest encoded data 602. A value of zero may be assigned to frequency 3 in place of weakest encoded data 602 so that a null is transmitted in frequency 3.

FIG. 6B is a spectrum illustrating an embodiment of rearranged encoded data so that the weakest encoded data is discarded. In the example shown, the spectrum may correspond to a transmitted signal generated by the system of FIG. 6A. Signal 652 may be transmitted by another wireless device and overlaps with frequency 3. Frequencies 1, 2, and 3 may correspond to subcarriers of a band. Stronger pieces of encoded data 650 are transmitted on frequencies 1 and 2, and a null is transmitted in frequency 3 after rearranging the ordering of the encoded data. Normally, the weakest encoded data is transmitted in frequency 1 and the stronger pieces of encoded data are transmitted in frequencies 2 and 3. The ordering of the encoded data is rearranged so that the weakest encoded data is discarded in the process of avoiding frequency 3.

In some embodiments, a set of subcarriers to suppress includes more than one subcarrier. Similar methods may be used to rearrange the ordering of data so that relatively less valuable data, equivalent to the number of subcarriers suppressed, is selected and discarded.

In some embodiments, the frequencies illustrated are bands used by a wireless device to transmit symbols. Similar to selecting less valuable data to discard when avoiding subcarriers, relatively less valuable symbols may be discarded when avoiding a band. In some embodiments, discarded data is selected based on a factor other than encoding strength.

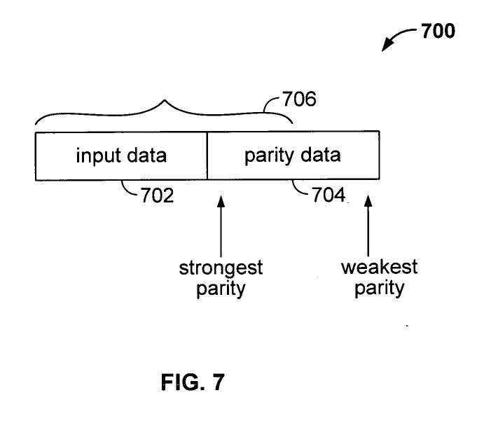

FIG. 7 illustrates an embodiment of a systematic code used in association with discarding data. In the example illustrated, the amount of data discarded varies in accordance with the bandwidth of a frequency spectrum to avoid. For example, if the number of subcarriers to avoid increases, more data is discarded. A systematic code generates encoded data that includes the input data used to generate the encoded data. Input data may be input to an encoder in a baseband processor, and encoded data 700 may be output by the encoder. Parity data 704 of encoded data 700 may also be generated by an encoder. In this example, parity data 704 is organized according to strength. Stronger parity data is located closer to input data 702 in the organization of coded data 700. As the distance from input data 702 increase, the strength of parity data 704 accordingly decreases. The weakest parity data may be located at the end of encoded data 700.

Using a systematic code as illustrated may be useful when discarding data in the process of avoiding a frequency spectrum. Transmitted data 706 varies based on the bandwidth of a frequency spectrum to avoid. Less of encoded data 700 is transmitted as the number of subcarriers to suppress increases. Organizing parity data 704 as such may enable a simpler design or a more elegant method of discarding data when avoiding a frequency spectrum.

In some embodiments, a systematic code is not used. An encoder may generate a non-systematic code and a puncturer may remove encoded bits based on the width of the frequency spectrum to avoid. For example, if N subcarriers in a band are suppressed, encoded data equivalent to N subcarriers may be removed by a puncturer. An alternate puncturing scheme may be used by a puncturer when subcarriers are suppressed. The amount of encoded data discarded by an alternate puncturing scheme may vary in accordance with the number of subcarriers to suppress. As the number of subcarriers to suppress increases, the amount of encoded data discarded increases. In some embodiments, the alternate puncturing scheme is determined in advance and is stored in a table. The size of the table may be limited because of memory constraints. For example, cases where 1 thru 5 subcarriers are suppressed may all map to the same puncturing scheme of discarding encoded data equivalent to 5 suppressed subcarriers.

Although the above figures illustrate some embodiments of discarding information in the processing of avoiding a frequency spectrum, in some embodiments information is not discarded. A wireless device may avoid a frequency spectrum without discarding information.

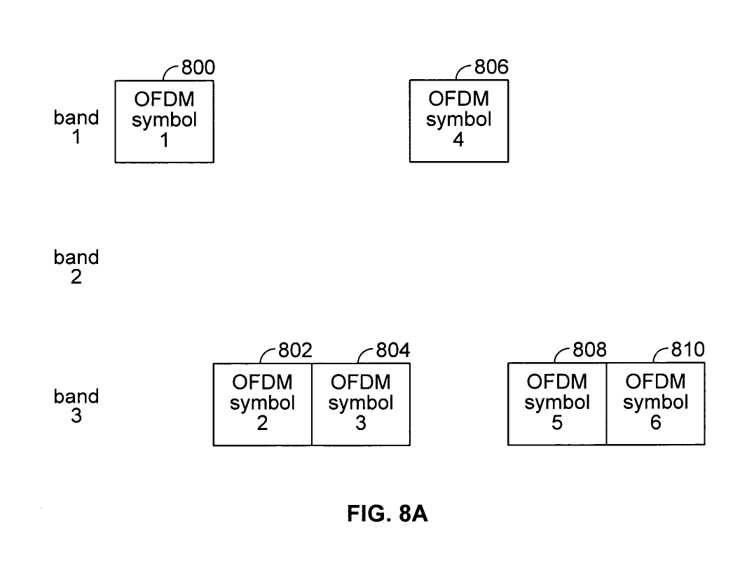

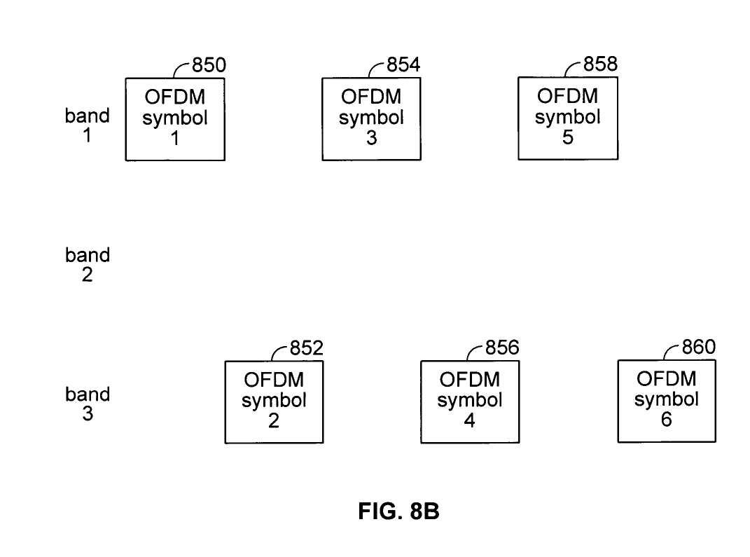

FIG. 8A is a transmission illustrating an embodiment of replacing an avoided band in a time frequency code with another band. In the example illustrated, a time frequency code of (band 1, band 2, band 3) is originally used. Another wireless device may begin using band 2, and band 2 is avoided. In the original time frequency code, band 2 is replaced with another band to produce a new time frequency code of (band 1, band 3, band 3). OFDM symbol 1 800 is transmitted on band 1, and OFDM symbol 2 802 and OFDM symbol 3 804 are transmitted on band 3. The pattern repeats and OFDM symbols 4 806, OFDM symbol 5 808, and OFDM symbol 6 810 are transmitted using the new time frequency code of (band 1, band 3, band 3). No information is discarded in the process of avoided band 2.

FIG. 8B is a transmission illustrating an embodiment of changing the time frequency code period to avoid a band. In the example illustrated, a time frequency code of (band 1, band 2, band 3) is originally used. Another wireless device may begin to use band 2 and band 2 is avoided. A new time frequency code of (band 1, band 3) is used, and the period of the new time frequency code (for example, two) does not equal the period of the original time frequency code (for example, three). OFDM symbol 1 850, OFDM symbol 3 854, and OFDM symbol 5 858 are transmitted in band 1 and OFDM symbol 2 852, OFDM symbol 4 856, and OFDM symbol 6 860 are transmitted in band 3 using the new time frequency code. A band may be avoided without discarding information.

A new time frequency code may be generated using a variety of methods. The period of the new time frequency code may be greater than the period of the original time frequency code. The number of bands used in a new time frequency code may not necessarily equal the number of bands used in the original time frequency code. A new band may be used in the new time frequency code. A TFI wireless device may become a FFI wireless device, using a single band to transmit symbols of a frame. The band used in FFI transmission may be a band included in the original time frequency code, or may be a new band.

In some embodiments, a transmitter communicates the new time frequency code so that the radio of a receiving wireless device may change to an appropriate band at an appropriate time to receive symbols. In some embodiments, wireless devices agree in advance to new time frequency codes a transmitting wireless device is allowed to switch to. This may limit the number of new time frequency codes a transmitter may use and enable more efficient communication. Codes assigned in advance may be shorter than explicitly describing all bands of the new time frequency code. In some embodiments, a modification applied to the original time frequency code may be described, such that a receiver may extract the new time frequency code using the communicated modification.

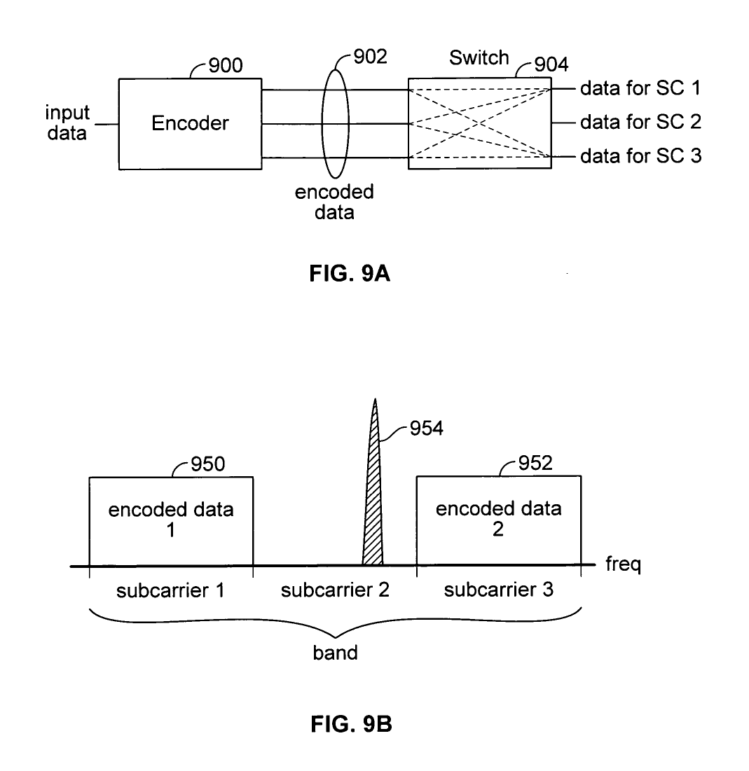

FIG. 9A is a block diagram illustrating an embodiment of components associated with buffering and assigning encoded data to subcarriers that are not suppressed. In the example shown, the components may be included in a baseband processor. Subcarrier 2 may be used by another wireless device and is suppressed. Encoded data 902 is output by encoder 900 and is passed to switch 904. Switch 904 buffers encoded data 902 and assigns the data to either subcarrier 1 or subcarrier 3. Switch may assign a zero value to subcarrier 2. This zero value may be passed to an IFFT such that a null is transmitted in subcarrier 2.

Switch 904 may include a first in—first out buffer (FIFO) to buffer encoded data 904. The output of the FIFO may be used as the next data assigned to a subcarrier. If the subcarrier is a subcarrier to suppress, a zero value may be assigned. Otherwise, the output from the FIFO may be assigned to the subcarrier. Using a FIFO may maintain the relative ordering of encoded data 902 with respect to each other. Zero values (assigned to subcarriers to suppress) are inserted between encoded pieces of data, but the relative ordering of encoded data may remain the same with respect to each other. It is not necessary for the ordering of encoded data 902 to remain the same and in some embodiments switch 904 rearranges an ordering. Using components as illustrated may enable a subcarrier to be suppressed without discarding information.

FIG. 9B is a spectrum illustrating an embodiment of suppressing subcarriers without discarding data. In the example shown, the spectrum may be generated by the components of FIG. 9A. Signal 954 may be transmitted by another wireless device and overlaps with subcarrier 2 of the band. Encoded data may be buffered so that a null is transmitted in subcarrier 2. Encoded data 1 950 is transmitted in subcarrier 1 and encoded data 2 952 is transmitted in subcarrier 3. Originally, encoded data 2 may have coincided with subcarrier 2. Encoded data 2 may be buffered and assigned to subcarrier 3. Subsequent data may also be buffered, so that encoded data 3 (not shown) is buffered and assigned to the next available subcarrier.

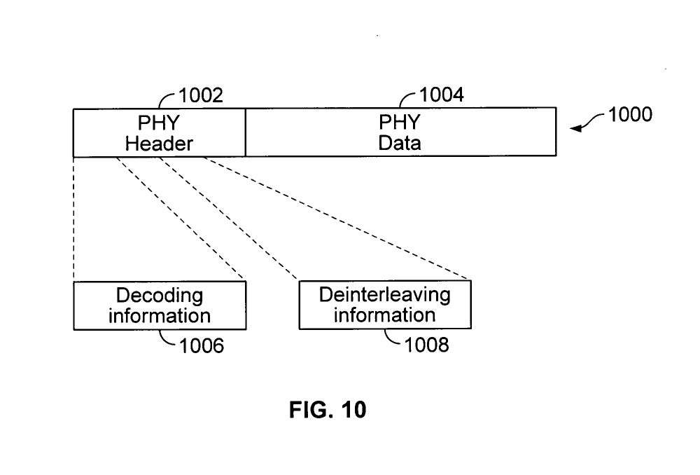

FIG. 10 illustrates an embodiment of a header used to communicate information about avoidance related processing performed on a frame. In the example shown, baseband frame 1000 may be generated by a baseband transmitter. Baseband frame 1000 includes PHY header 1002 and PHY data 1004. A MAC frame passed to a baseband processor from a MAC may be included in PHY data 1004. Processing (including encoding, puncturing, modulation, and interleaving) may be applied to the MAC frame to obtain PHY data 1004. PHY header 1002 may be used by a receiver to determine appropriate processing to apply to baseband frame 1000. For example, a data rate may be specified in PHY header 1002 and appropriate processing may be determined based on the data rate in the PHY header.

Decoding information 1006 is included in PHY header 1002. Information that may be used in decoding baseband frame 1000 may be communicated in decoding information 1006. In some wireless devices, a baseband receiver includes a Viterbi decoder. Decoding information 1006 may be used to communicate when to insert neutral values into the Viterbi decoder. For example, information is discarded and a zero value inserted in its place in the examples of FIG. 4, FIG. 6A, and FIG. 6B. Using decoding information 1006, a neutral value may be input to the Viterbi decoder instead of a received value that may introduce noise.

PHY header 1002 includes deinterleaving information 1008. Deinterleaving information 1008 may communicate information used to deinterleave baseband frame 1000. A rearrangement of an ordering of data applied at a transmitter to avoid a frequency spectrum may be communicated using this field in the PHY header. Deinterleaving information 1008 may communicate the reordering performed by switch 606. A Viterbi decoder may be expecting the original ordering without the reordering of switch 606 applied, and a deinterleaver may use deinterleaving information 1008 to obtain the original ordering. In some embodiments, deinterleaving information 1008 includes information used by a receiver to remove extraneous data. The examples of FIGS. 9A and 9B buffer encoded data that coincide with a subcarrier to suppress. Zero values are inserted for a subcarrier to avoid, and this extraneous data may be removed at a receiver. Deinterleaving information 1008 may communicate the insertion of extraneous zero values.

In some embodiments, information is not discarded when avoiding a frequency spectrum and the length of a frame may increase. The increased length of the frame may be calculated and included in PHY header 1002. For example, if encoded data is buffered and assigned to subcarriers that are not suppressed, the number of symbols, and accordingly the length of the frame, may increase.

In some embodiments, an extended PHY header is used. In some applications, there may not be enough unassigned fields in PHY header 1002, or it may be undesirable to communicate avoidance related information in every PHY frame. An extended PHY header may be used, where a bit in PHY header 1002 indicates the presence of an extended PHY header. If the extended PHY header bit is set, an extended PHY header may be included in baseband frame 1000, for example between PHY header 1002 and PHY data 1004. In some embodiments, more than one extended PHY header exists and an identifier at the beginning of the extended PHY header may be used to differentiate between extended PHY headers. Avoidance related information, such as decoding and deinterleaving information, may be included in the extended PHY header.

In some embodiments, frames are used to communicate avoidance related information. In some cases, the wireless medium may change relatively slowly, for example on the order of minutes, hours or days. In a home, a wireless device may enter and remain for at least few hours. A frequency spectrum to avoid in the house may remain constant during that time. A frame may be used to communicate avoidance related information. A new time frequency code, information discarded, nulls transmitted, and/or a rearrangement of an ordering may be communicated using frames.

In some embodiments, processing associated with a lower data rate is used when avoiding a frequency spectrum. A MAC may pass a data rate to a baseband processor in association with a frame. Baseband processing applied to the frame may be determined by the data rate. A specification (such as the WiMedia specification) may define allowed data rates and processes such as encoding, modulation and interleaving applied to a frame are based on the data rate specified. To compensate for the increased error rate from discarding information, a baseband processor may apply processing associated with a data rate lower than the data rate received from a MAC. For example, a specification may describe an 80 Mbps data rate and a 160 Mbps data rate. A baseband processor that receives a frame with a 160 Mbps data rate assigned may decide to apply processing associated with the 80 Mbps data rate. Lower data rates may have a tendency to be more robust than higher data rates and may compensate for an increased error rate resulting from discarding information.

In some embodiments, another device besides a baseband processor determines whether to use lower data rate and if so, the lower data rate to use. For example, a MAC may have more knowledge of the state of the wireless device, traffic, and/or the wireless medium. A MAC may determine a lower data rate to use and pass the lower data rate to a baseband processor. The baseband processor may be constrained in such cases to use the data rate specified by the MAC since the data rate is already reduced.

An avoidance rate drop table may be used to specify a lower data rate to use when discarding information. In addition to the original data rate assigned to a frame, information discarded may be considered. As the amount of information discarded increases, lower data rates may be selected. In some embodiments, the avoidance rate drop table is fixed. For example, wireless devices may agree in advance to use certain lower data rates. A specification may describe allowable lower data rates that may be used when discarding information. In some embodiments, the avoidance drop rate table is not fixed. For example, software may set rates in the avoidance drop table.

Using a lower data rate may enable existing wireless devices to receive frames with discarded information at an acceptable error rate. Error rate may be more of a concern for higher data rates than lower data rates which tend to be more robust. Additional signaling and/or additional functionally may not be needed to obtain an acceptable error rate if a lower data rate is used. An existing receiver may be able to process the spectrum of FIG. 4 at an acceptable error rate without knowledge of avoidance related processing applied. Additional circuitry to use a neutral value in place of a value received in subcarrier 2 may not necessarily be needed to have an acceptable error rate at the receiver.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of avoiding a frequency spectrum in a wireless medium, comprising:
obtaining an identification of the frequency spectrum in the wireless medium to avoid;
determining a set of subcarriers to suppress based at least on part on the frequency spectrum to avoid; and
reallocating information in response to the set of subcarriers to suppress.

2. A method as recited in claim 1, wherein the method is performed by an ultrawideband (UWB) wireless device.

3. A method as recited in claim 1, wherein the frequency spectrum to avoid is associated with a narrowband wireless device.

4. A method as recited in claim 1, wherein at least one of the set of subcarriers to suppress does not overlap with a band used by another wireless device transmitting in the wireless medium.

5. A method as recited in claim 1, wherein obtaining the identification includes receiving a range of frequencies.

6. A method as recited in claim 1, wherein obtaining the identification includes identifying a band used by a wireless device transmitting in the wireless medium.

7. A method as recited in claim 1, wherein reallocating information is based at least in part on a data rate.

8. A method as recited in claim 1, wherein reallocating information includes evaluating a degree to which a potential reallocation of information affects performance.

9. A method as recited in claim 1, wherein reallocating information includes evaluating a degree to which a potential reallocation of information affects performance, including an error rate.

10. A method as recited in claim 1, wherein reallocating information includes evaluating a degree to which a potential reallocation of information affects performance, including a transmission rate.

11. A method as recited in claim 1, wherein reallocating information includes using a band that does not include the frequency spectrum to avoid.

12. A method as recited in claim 1, wherein reallocating information includes using a new band.

13. A method as recited in claim 1, wherein reallocating information includes setting values associated with the set of subcarriers to suppress to substantially zero values.

14. A method as recited in claim 1, wherein reallocating information includes not transmitting in the frequency spectrum to avoid.

15. A method as recited in claim 1, wherein:
reallocating information includes not transmitting in the set of subcarriers to suppress; and
a component associated with transmission is turned off during a non transmission period.

16. A method as recited in claim 1, wherein:
reallocating information includes discarding information associated with the set of subcarriers to suppress; and
the discarded information includes information generated using a relatively weak code.

17. A method as recited in claim 1, wherein:
reallocating information includes discarding information associated with the set of subcarriers to suppress; and
the discarded information includes information generated using a relatively weak code, including a weakest code.

18. A method as recited in claim 1, wherein:
reallocating information includes discarding information associated with the set of subcarriers to suppress; and
the discarded information is selected.

19. A method as recited in claim 1, wherein:
reallocating information includes discarding information associated with the set of subcarriers to suppress; and
the discarded information is selected by rearranging an ordering.

20. A method as recited in claim 1, wherein reallocating information includes:
storing data to transmit; and
assigning the stored data to at least one subcarrier other than the set of subcarriers to suppress.

21. A method as recited in claim 1, further including receiving a data rate associated with data to transmit, wherein reallocating information includes processing the data to transmit using processing associated with a data rate lower than the received data rate.

22. A method as recited in claim 1, wherein reallocating information includes discarding encoded data using an alternate puncturing scheme.

23. A method as recited in claim 1, wherein reallocating information includes discarding encoded data using an alternate puncturing scheme, such that the amount of encoded data discarded by the alternate puncturing scheme varies in accordance with the number of subcarriers to suppress.

24. A method as recited in claim 1, further including communicating information associated with the step of reallocating information to a receiver.

25. A method as recited in claim 1, further including communicating information associated with the step of reallocating information to a receiver using a PHY header.

26. A method as recited in claim 1, further including communicating information associated with the step of reallocating information to a receiver using an extended PHY header.

27. A method as recited in claim 1, further including communicating information associated with the step of reallocating information to a receiver using a frame.

28. A method as recited in claim 1, further including:
communicating information associated with the step of reallocating information to a receiver; and
using the communicated information at the receiver to process a signal received via the wireless medium.

29. A method as recited in claim 1, further including:
communicating information associated with the step of reallocating information to a receiver; and
using the communicated information at the receiver to process a signal received via the wireless medium, including using a neutral value instead of a received value.

30. A method as recited in claim 1, further including:
communicating information associated with the step of reallocating information to a receiver; and
using the communicated information at the receiver to process a signal received via the wireless medium, including discarding a received value.

31. A method as recited in claim 1, further including:
communicating information associated with the step of reallocating information to a receiver; and
using the communicated information at the receiver to process a signal received via the wireless medium, including rearranging an ordering.

32. A system for avoiding a frequency spectrum in a wireless medium, comprising:
a processor configured to:
obtain an identification of the frequency spectrum in the wireless medium to avoid;
determine a set of subcarriers to suppress based at least on part on the frequency spectrum to avoid; and
reallocate information in response to the set of subcarriers to suppress.

33. A computer program product for avoiding a frequency spectrum in a wireless medium, the computer program product being embodied in a computer readable medium and comprising computer instructions for:
obtaining an identification of the frequency spectrum in the wireless medium to avoid;
determining a set of subcarriers to suppress based at least on part on the frequency spectrum to avoid; and
reallocating information in response to the set of subcarriers to suppress.
